(19) United States
(12) Patent Application Publication
(10) Pub. No.: US 2022/0351318 A1
(43) Pub. Date: Nov. 3, 2022

(54) USER BEHAVIOR-BASED RISK PROFILE RATING SYSTEM

(71) Applicant: WAY INC., Fremont, CA (US)

(72) Inventor: Binumon Thamarashn GIRIJA, Sunnyvale, CA (US)

(73) Assignee: WAY INC., Fremont, CA (US)

(21) Appl. No.: 17/733,881

(22) Filed: Apr. 29, 2022

Related U.S. Application Data
(60) Provisional application No. 63/182,404, filed on Apr. 30, 2021.

(51) Int. Cl. G06Q 50/26; G06N 3/08

(52) U.S. Cl. CPC G06Q 50/265; G06N 3/08

(57) ABSTRACT

The present subject matter refers to a method implemented in a behavior-based risk-profiling system for profiling a user. The method includes receiving an input data from at least one user through at least one user interface, receiving an interaction data associated with an interaction of the at least one user assessed from the at least one user interface, determining a risk profile of the at least one user based on a data set comprising the input data and the interaction data, and providing at least one service to the user based on the risk profile of the user.

### RELATED APPLICATION(S)

This application claims priority under 35 U.S.C. § 119(e) of the co-pending U.S. Provisional Patent Application Ser. No. 63/182,404, filed Apr. 30, 2021, and titled “User Behavior-Based Risk Profile Rating System,” which is hereby incorporated by reference in its entirety.

### FIELD OF THE INVENTION

The embodiments discussed in the present disclosure are generally related to risk assessment while filling online form(s). In particular, the embodiments discussed are related to user behavior-based risk profile rating systems and methods.

### BACKGROUND OF THE INVENTION

With the advent of new technologies and growing popularity of smartphones, tablets, and gadgets, there has been a rapid increase in the number of users accessing online websites and applications for various products/services. There is a corresponding increase in the number of online services provided by a multitude of service providers. For availing certain online services, users may be required to input details in one or more online forms. However, the details entered by the individual users may be incorrect or of a fraudulent nature. Hence, it may be risky for the service providers to offer services to such users who have an intent to game or fraud the system.

In an example, a user seeking an insurance policy online may deliberately submit incorrect details online to enable a low insurance premium calculation that otherwise may not be deserved by him. In other example, a salesman who may be an aspirant of meeting sales targets may attempt either submission of fabricated data or incorrect details of a client to attempt seeking insurance policy issued for the otherwise undeserving client.

Conventionally, such fraudulent practices are only discovered upon the materialization of a contract or in other words, upon an insurance policy having been underwritten. Therefore, there lies at least a need to detect such fraud, irregularities, anomalies etc. in real-time, i.e. prior to the materialization of contract or underwriting the insurance policy. There is a need to beforehand alert a service provider about such fraudulent users attempting at outsmarting the online systems, before an application is submitted.

### SUMMARY OF THE INVENTION

Embodiments of user behavior-based risk profile rating systems and methods are disclosed that address some of the above challenges and issues.

In a first aspect, the present subject matter is directed to a method implemented in a behavior-based risk-profiling system for profiling a user. The method includes receiving an input data from at least one user through at least one user interface, receiving an interaction data associated with an interaction of the at least one user assessed from the at least one user interface, determining a risk profile of the at least one user based on a data set comprising the input data and the interaction data, and providing at least one service to the user based on the risk profile of the user.

In an embodiment, the determining of the risk profile includes predicting a risk associated with the at least one user based on the input data and the interaction data. The predicting the risk is in turn based on computing a risk assessment score associated with the at least one user, and classifying the computed risk assessment score to indicate the risk associated with the at least one user.

In an embodiment, the providing of the at least one service to the user based on the risk profile of the user includes deciding to provide the at least one service to the at least one user based on a determination of the risk profile.

In an embodiment, at least one artificial neural network (ANN) is trained based on the data set including the input data and interaction data received over a period of time. The ANN is implemented to predict the risk associated with the at least one user. The prediction of the at least one ANN is validated based on a communication from a remote server to determine that the at least one user is the defaulter and/or to identify the at least one portion of the data as anomalous. The validation may also be based on a historical data received from a knowledge database to determine that the at least one user is the defaulter and/or to identify the at least one portion of the data as anomalous.

In a second aspect, the present subject matter is directed to a method of determining service eligibility of a user based on a behavior-based risk profiling system. The method includes receiving an input data from a user through at least one user interface and thereby receiving an interaction data of the user with the at least one user interface. A risk profile associated with transacting of service provider with the user is determined based on the input data and the interaction data. In an example, at least one artificial neural network (ANN) may be trained based on a data set including the input data and the interaction data for predicting a risk profile associated with transacting of a service provider with the at least one user. Thereafter, for the user, an eligibility to receive a service or a service eligibility is determined based on the prediction of the risk profile.

In an embodiment, the user interface includes at least one application form including a plurality of fields for receiving the input data. Further, the interaction data may be received at the at least one user device of the user.

In an embodiment, at least one artificial neural network (ANN) may be trained based on a data set including the input data and interaction data received over a period of time. Accordingly, the ANN is implemented to predict the risk associated with the at least one user. Further, the prediction of the ANN is validated based on a communication from a remote server to determine that the user is the defaulter and/or to identify the portion of the data as anomalous. Such validation may be also based on a historical data received from a knowledge database.

In an embodiment, the determining of the service eligibility of the user includes selecting the user corresponding to the risk profile.

In an embodiment, the determining the service eligibility is based on determining a likelihood of the user being a defaulter for the service, and/or identification of at least one portion of the input data received from the user as fraudulent.

In an embodiment, the prediction of the at least one ANN is validated based on communication received from a remote server to determine the at least one user as the defaulter and/or to identify the at least one portion of the data as anomalous.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example of an operating environment in which a user behavior-based risk profile rating system may be utilized in accordance with an embodiment.

FIG. 2 illustrates a signal flow diagram for user behavior-based risk profile rating in accordance with an embodiment.

FIG. 3 illustrates a block diagram of a server for user behavior-based risk profile rating in accordance with an embodiment.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown but is to be accorded the widest possible scope consistent with the principles and features disclosed herein.

In the present times, a plethora of user-friendly applications (also called apps) and/or websites are available on online markets/app store/Internet pertaining to every industry. As the online interaction and activities of users increase on these internet-based apps and websites, it is imperative for industries like banking, finance, insurance etc. to detect potentially fraudulent or suspicious activity with an aim to reduce the chances of risk while entering into commercial contracts with their customers. Current online portals that facilitate online form filling for the purpose of underwriting policies fail to address this concern. Accordingly, there is a need for systems and methods that take a holistic approach for rating an individual's risk profile/intent to game or fraud the system.

In yet another scenario, in the field of insurance, lenders and insurers may rely on credit ratings and other demographic data to determine risk when extending loans or underwriting policies. For example, the credit ratings may be based on parameters such as, but not limited to, age, gender, address, employment, income, assets, on time re-payment history, and accident history, etc. In some of the existing models, lender/insurer employs an agent directly interacting with customers as they provide the data related to the above-mentioned parameters. This approach involving human interaction, allows the agent to exercise subjective judgement on the intention and veracity of information provided by customers. With the move to internet-based applications and/or online websites, the human element may be perceived as inconvenient and is often omitted from the process. Existing online portals and internet-based applications/sites may not be able to replicate the human capability of judging fraudulent behavior of customer(s).

For purchasing or availing certain services on the internet-based applications and/or online websites, a user may choose to use an app on any of the user devices such as a smartphone, laptop, tablet etc. The user may further decide whether to use such an app by downloading from an app store or visiting the associated website on world wide web offering the required service. Once the required service is selected on the app or website, a user may have to input details such as name, phone number, and other service specific details. In other words, the user is required to fill an application form to purchase the service. While filling the application form, the user may perform a search on any search engine, open websites in another window, perform comparisons, tweak or play around with various options on the application form, and/or change answers to the questions asked etc. It will be beneficial for service providers offering these services to detect such user behavior in order to determine whether it will be risky to offer service to the user. Accordingly, the user behavior can be taken into consideration to build a digital fingerprint for that user session. Various pattern recognition algorithms may be applied to understand one or more patterns that are pre-classified into various risk patterns or categories.

The proposed system will collect interaction signals as the user interacts with the app or relevant web pages on the website while they are filling the application form for a service to be availed. These interaction signals will provide a digital fingerprint similar to what a human agent would pick up in a direct interaction with the user. This digital fingerprint or behavior profile will provide additional insights into creating a risk profile of the user. Accordingly, the disclosed approach enables the service providers to assess the risk before signing the commercial contracts with the users for one or more services while addressing the above noted concerns and challenges.

Certain terms and phrases have been used throughout the disclosure and will have the following meanings in the context of the ongoing disclosure. “MVR” refers to a Motor Vehicle Record, which includes information on traffic violations, accident history, parking tickets, convictions like driving under the influence (DUI), license suspensions, license restrictions, etc. “App” is an application available on multiple online app stores which provides services such as Insurance, Car Parking, Car Wash, and other services. The other services may include but are not limited to fun/adventure activities, movies, dining, transportation, and events. “Website” refers to a website or web pages providing services similar to the app. “Platform” refers to basic hardware and operating system on which the app runs or the website is accessed by a user. “Non-personal identity information” is information that, without the aid of additional information, cannot be directly associated with a specific person. “Personal identity information” is information such as a name or email address that can be directly associated with a specific person. The term “database”, as used herein, may refer to an organized collection of structured information, or data, typically stored electronically in a computer system. “Machine learning (ML)” is a type of artificial intelligence (AI) that allows software applications to become more accurate at predicting outcomes without being explicitly programmed to do so. “Supervised ML” is the type of machine learning in which machines are trained using well “labelled” training data, and on basis of that data, machines predict the output. “Labelled data” means some input data is already tagged with the correct output. “Neural networks” are machine learning models that employ one or more layers of non-linear computing units such as artificial neurons to predict an output for a received input. Some neural networks are deep neural networks that include one or more hidden layers in addition to an output layer. The output of each hidden layer is used as input to the next layer in the network, i.e., the next hidden layer or the output layer. Each layer of the network generates an output from a received input in accordance with current values of a respective set of parameters. “Validation data set” is a dataset that provides an unbiased evaluation of a model fit on the training data set while tuning the model's hyperparameters. “Test data set” is a data set used to provide an unbiased evaluation of a final model fit on the training data set. “Deep learning” may refer to a family of machine learning models composed of multiple layers of neural networks, having high expressive power and providing state-of-the-art accuracy.

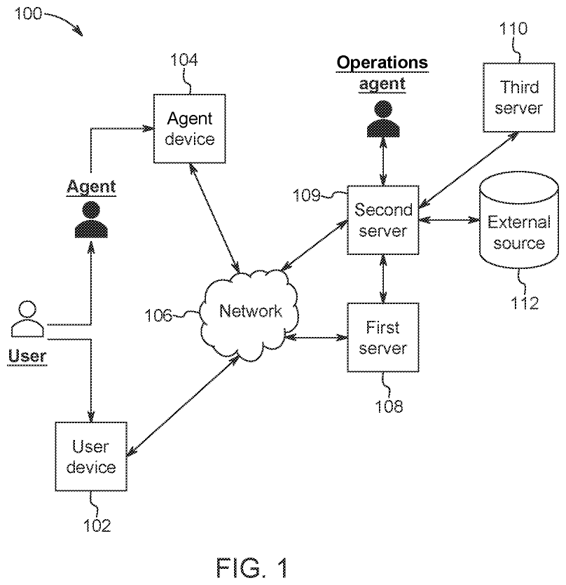

FIG. 1 illustrates an operating environment in which a user behavior-based risk profile rating system may be utilized in accordance with an embodiment of the disclosure. In FIG. 1, an exemplary operating environment 100 is depicted. The exemplary operating environment 100 may include a user device 102 associated with a user, an agent device 104 associated with an agent, a network 106, a first server 108, a second server 109 associated with an operations agent, a third server 110, and an external source 112.

The user device 102 may include a display screen for the user to interact with an app downloaded on the user device 102 or a website accessed through the Internet. In an embodiment, the app may provide following options to the user such as but not limited to parking services, vehicle service/repair, guided maps, insurance, car wash, etc. In an embodiment, the website may be a website for users to buy policies online. In an embodiment, the user may select, via the user device 102, a service on the app or website and may interact with the platform to purchase the service. In another embodiment, the user may opt to interact with the agent (as depicted) who operates a device, such as the agent device 104. In such a scenario, the user and the agent may exchange information or data related to the service, such as through telephone call(s), so that an application form for underwriting a policy is filled by the agent, via the agent device 104, on behalf of the user. In an embodiment, when a web page loads on the user device 102 upon selection of a service on the app or website by the user, a module or plug-in may be invoked. The module or plug-in may detect user behavior such as a sequence of clicks or actions performed by the user, via the user device 102, while filling the application form. In an embodiment, the actual data entered by the user via the user device 102 or the agent via the agent device 104 on behalf of the user in various input fields of the application form may be captured separately from the detected user behavior data.

In an embodiment, the user device 102 may include but is not limited to a mobile device, a smartphone, a personal computer, a laptop, a desktop, a netbook, a tablet, an internet-enabled television, a smart TV, a personal digital assistant (PDA), a touch screen device, a smartwatch, and/or a wearable device.

The agent device 104 may be a device operated by an agent, who acts as an intermediary between the user seeking a service and a server providing the requested service, such as the first server 108 and the second server 109. In an embodiment, the agent device 104 may be a proxy server. In another embodiment, the agent device 104 may be a device operated by an agent or sales executive of the service provider. It will be apparent to a person with ordinary skill in the art that the agent may fill the application form on a web page on behalf of the user via the agent device 104, where the web page may be hosted on a private network of a service provider/agent. In yet another embodiment, the agent device 104 may be a device used for authenticating or verifying the information entered by user via the user device 102 on the platform. In an embodiment, when the web page loads on the agent device 104 for filling the application form on behalf of the user then a module or plug-in may be invoked. The module or plug-in may detect agent behavior such as a sequence of clicks or actions performed by the agent, via the agent device 104, while the agent fills the application form.

The user device 102 may communicate via wireless communication with a network 106, such as the Internet, an Intranet and/or a wireless network, such as a cellular telephone network, a wireless local area network (WLAN) and/or a metropolitan area network (MAN). The wireless communication may use any of a plurality of communication standards, protocols and technologies, such as Long Term Evolution (LTE), LTE-Advanced, Global System for Mobile Communications (GSM), Enhanced Data GSM Environment (EDGE), wideband code division multiple access (W-CDMA), code division multiple access (CDMA), time division multiple access (TDMA), Single-Carrier Frequency Division Multiple Access (SC-FDMA), Orthogonal Frequency Division Multiple Access (OFDMA), Bluetooth, Wireless Fidelity (Wi-Fi) (such as IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

In an embodiment, the network 106 facilitates communication between the user device 102, the agent device 104, the first server 108, and the second server 109 so that the user can seek resources for one or more services on the platform.

The first server 108 may be communicably coupled with the second server 109, the user device 102, and the agent device 104 via the network 106. In an embodiment, the first server 108 may communicate with the user device 102 or the agent device 104 to capture input data entered in various input fields of the application form while availing a service by the user or the agent on behalf of the user. In an embodiment, the first server 108 may be configured to send the captured input data to the second server 109 based on certain conditions associated with computing the risk assessment associated with the user. In an embodiment, the first server 108 may be configured to send the captured input data to the second server 109 based on a determination by the second server 109. In an embodiment, the first server 108 may store the input data for a plurality of users interacting with the app or website via respective user devices.

The second server 109 may be communicably coupled with the first server 108, the third server 110, and the external source 112. Further, the second server 109 may communicate with the user device 102 and the agent device 104 via the network 106. In an embodiment, the second server 109 may host the server-side components of the app or the website. In an embodiment, the second server 109 may be implemented as a centralized server computing device with adequate processing power to cater to given number of app users or website traffic.

For example, through the registration process and/or through user account settings, the first server 108 may store personal identity information of users such as name, email address, phone number, and third-party account credentials. In an embodiment, the second server 109 may store non-personal identity information such as user's Internet Protocol (IP) address, operating system and browser type, and the location of each web page the user views right before arriving at, while navigating and immediately after leaving the website or while filling the application form on the app. In an embodiment, the second server 109 may capture a location of the user device 102 while filling the application form based on IP address or Global Positioning System (GPS) co-ordinates of the user device 102 as non-limiting examples. In an embodiment, the captured location of the user device 102 may enable the user behavior-based risk profile rating system to provide localized options to the user(s) for other services offered on the platform, such as but not limited to car parking, car wash, location-based events etc.

In an embodiment, the user(s) may be informed regarding the collection/storage of personal identity information and non-personal identity information on the website or app. In an embodiment, the user(s) may give permission as an electronic trigger to the service provider to collect the non-personal identity information through accepting use of web cookies on the web site. In an example, such permission may be sought from the user through sending a prompt at the user device. The prompt may be communicated as a pop window to the user to request immediate response. In other scenario, the user may voluntarily often check incoming request within an incoming requests based inbox either in a website based application or a local application. However, it will be apparent to a person with ordinary skill in the art that users who do not wish to have web cookies placed on their computers may set their browsers to refuse web cookies before accessing the web site, with the understanding that certain features of the web site may not function properly without the aid of web cookies.

In an embodiment, the second server 109 may be configured to receive one or more interaction signals from the invoked module or plugin from the app or website periodically. The one or more interaction signals relate to one or more movements detected by a web beacon, module, or plug-in on the web page while the user interacts with the app or website. A web beacon is an object that is embedded in a web page that is usually invisible to the user and allows website operators to check whether a user has viewed a particular web page or an email. Web beacons are not used to access users' personal identity information. However, they are a technique that the website may use to compile aggregated statistics about the website usage. In an embodiment, a user may disable cookies and web beacon(s) can be rendered ineffective. In an embodiment, a user may modify browser settings on the user device 102 so that the user is notified each time a web cookie is present, and authority lies with the user to accept or decline web cookies on an individual basis.

In an embodiment, the second server 109 may analyze the one or more interaction signals received periodically from the user device 102 via the network 106 to compute or determine a risk profile of the user. In an implementation, but not limited to, the computing or determining of the risk profile may be construed as creation of the risk profile. In an embodiment, the second server 109 may analyze the one or more interaction signals received periodically from the agent device 104 via the network 106 or any private network to create a risk profile of the user. In an embodiment, the second server 109 may analyze the one or more interaction signals received from the user device 102 or the agent device 104 along with the input data received from the first server 108 to create the risk profile of the respective user or compute the risk assessment score. In an embodiment, the second server 109 may access the input data entered into the application form from (stored in) the first server 108 based on a determination that the attributes of content entered by the user via the user device 102 are required while computing the risk assessment score or during the analysis. In an embodiment, the second server 109 may access the personal identity information of users from the first server 108 based on a determination that the personal identity information is required while computing the risk assessment score or during the analysis. In an embodiment, the second server 109 may access the input data and/or the personal identity information of users from the first server 108 along with the received one or more interaction signals for aid in the analysis or to compute the risk assessment score. In an example, the determination of risk profile with respect to the user also includes accessing a previously determined/stored risk assessment score for comparison vis-à-vis the currently computed risk assessment score and accordingly, contribute to harmonize the current computed risk score. In an example, an extremely low currently computed risk score may be augmented by a prescribed margin in case a counterpart historical risk assessment score has been relatively higher than the currently computed risk assessment score. Likewise, an overly high risk current computed risk assessment score may be downsized by prescribed margin based on comparison with the historical risk assessment score. In other example, the historical risk assessment score may be simply reported as a parameter along with current computed risk assessment score.

In an embodiment, the second server 109 may be associated with an operations agent who may undertake decisions related to analyzing or monitoring the one or more interaction signals received from the user device 102 and/or the agent device 104. In an embodiment, the operations agent within the second server 109 may be an entity (e.g., robot, humanoid robot or artificial intelligence based application) associated with the service provider different than the agent. In an embodiment, the second server 109 may analyze the interaction of each agent with the user behavior-based risk profile rating system and/or historic data associated with policies sold by each agent to detect suspicious behavior of the agent. For example, when the agent tries to game the user behavior-based risk profile rating system or play around with the options on the web page to meet his/her targets, the user behavior-based risk profile rating system can detect such notorious or unethical behavior. The operations agent may detect such behavior of the agent(s) based on the analysis by the second server 109 and/or the input data received from the first server 108.

In an embodiment, the input data received by the second server 109 from the first server 108 may be utilized to determine fraudulent behavior of the user when the application form is being filled by the agent on behalf of the user. In such a scenario, the second server 109 may indicate to the agent via a notification on the agent device 104 that the user whose application form is being filled is suspicious or risky.

In an embodiment, the risk profile of each user may classify the user as being highly risky, moderately risky, or safe (e.g., no or minimal risk). In an embodiment, the second server 109 may store the risk profile of each user in an associated database. In an embodiment, the second server 109 may indicate safe users or non-risk users in green, moderate risk users as yellow/amber, and high-risk users as red while storing the risk profiles of each user. In an embodiment, the second server 109 may analyze the one or more interaction signals in real-time, near-real time, or non-real time to create the risk profile of the user. In an embodiment, the risk profile of the users may be used by companies to determine whether it is safe to proceed for underwriting a policy for the user or not. In an embodiment, the second server 109 may compute a rating for each user based on the risk profile. The rating may pertain to a specific rating for no-risk/safe, moderate risk, and high-risk users. However, the type of rating may change based on several factors, such as but not limited to number of users and time period.

In an embodiment, the second server 109 may implement an artificial neural network (ANN) as part of incorporating Artificial Intelligence (AI) module. The ANN may be trained based on a data set including several values of input data and interaction data received and accumulated over a period of time. The trained ANN thereafter predicts the risk associated with the user. The prediction from the ANN may be validated based on a communication from a remote server to determine that the at least one user is the defaulter and/or to identify the at least one portion of the data as anomalous. The validation may also include receiving a historical data from a knowledge database to determine that the at least one user is the defaulter and/or to identify the at least one portion of the data as anomalous.

In an embodiment, the second server 109 may utilize the real-time or non-real-time analysis of the one or more interaction signals received from the user device 102 or the agent device 104 via the network 106 in multiple ways.

For instance, in a first scenario, an agent who fills the application form, via the agent device 104, for purchasing a policy on the behalf of the user may receive a result of the analysis performed by the second server 109. In such a scenario, the agent device 104 may receive an indication that the user whose application form is being filled is high-risk, moderate risk, or safe based on the analysis performed by the second server 109. In an embodiment, the indication of the user being high-risk, moderate risk, or safe may be displayed on a screen of the agent device 104. In an embodiment, the agent device 104 may be notified by the second server 109 that the user whose application form is being filled is serious about purchasing the policy or not. The seriousness of closing the purchase deal may be ascertained by the second server 109 by analyzing the one or more interaction signals captured from the agent device 104. For example, the user may be asking the agent to change numbers on the fields provided on the application form. As a result, the agent may be changing the fields on the application form displayed on the agent device 104. The second server 109 may analyze the one or more interaction signals captured from the agent's interaction with the web page and determine that the chances of closing the purchase deal with the user are less. Accordingly, the second server 109 may send a notification or indication to the agent device 104 that the chance of closing the deal is low, and the agent device 104 may take an action accordingly.

In a second scenario, the second server 109 may feed the result of analysis of the one or more interaction signals in a form of rating or rank associated with the assessed user to the third server 110. The third server 110 may be associated with service provider(s). The third server 110 may consider the user's rating or ranking for taking decisions related to entering into commercial contracts for a service that the user may purchase.

In a third scenario, the second server 109 may use the analysis of the one or more interaction signals associated with the user to determine whether a commercial contract shall be underwritten for the user or not based on the risk profile.

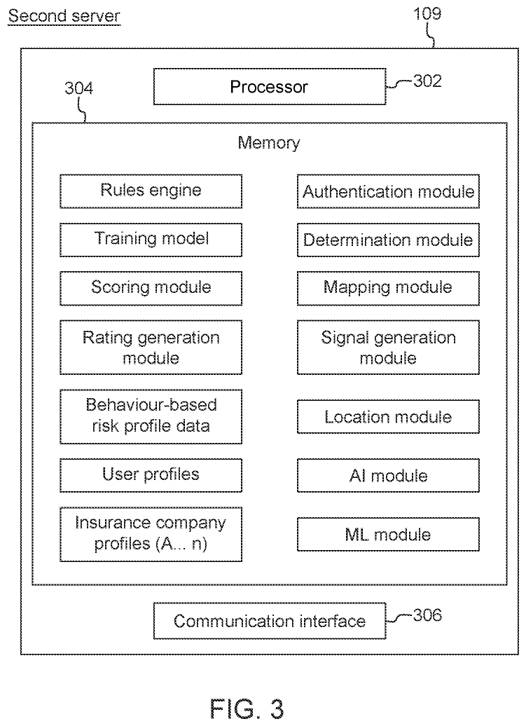

The second server 109 may include a plurality of modules that are designed to perform a plurality of functions. The plurality of modules included in the second server 109 will be explained later in description of FIG. 3. By virtue of such plurality of modules one or more of which may be based on ANN or other AI techniques, the second server 109 is able to determine an eligibility of the user to receive at least one service based on selecting the at least one user corresponding to the risk profile certified as the moderate risk or the low risk profile. The user corresponding to the high risk profile is rejected and refrained from availing the service.

The third server 110 may be one or more servers linked to companies that provide services on the app or website. In an embodiment, the app or website provides a platform to service providers to market and advertise their products. Accordingly, as described previously, it is important for the second server 109 to determine the risk profile of each user and convey the result of the risk assessment to the third server 110 for reducing the risk of engaging with risky customers. In an embodiment, the third server 110 may be a company that decides to refrain from underwriting a policy for fraudulent or suspicious users based on the risk profile. In an example, such refraining may be based on determining a likelihood of the at least one user being a defaulter for the service, and/or identifying at least one portion of the input data received from the at least one user as fraudulent. In example, the second server 109 refers to the third server 110 (which may be a remote server) for validating the prediction of the at least one ANN by receiving a communication from the third server 110 to determine that the user is the defaulter and/or to identify the at least one portion of the input data as anomalous to facilitate analysis and a decision making.

The external source 112 may be an external database to access user historical data. The user historical data may pertain to motor vehicle records (MVRs), credit history, etc.

In an embodiment, the external source 112 may be a repository where MVRs are stored and that may be accessed by the second server 109. In an embodiment, the MVRs may be pulled from governmental agencies (such as Department of Motor Vehicle (DMV)) and/or consumer reporting agencies that have access to MVRs by paying the requisite fees. In an embodiment, the MVRs of a particular user may be pulled for certain years, such as but not limited to three years or five years from the time of applying for an insurance policy. In an embodiment, the MVR of a user may be pulled by the service provider such as before and/or at the time of underwriting an insurance policy for the user. In an embodiment, the MVR of the user may be accessed by one or more insurances companies directly while underwriting the policy for the user. In an embodiment, the MVR of the user may be provided by the second server 109 to the one or more insurance companies. In an embodiment, the MVR of the user may be accessed by at least one of the first server 108, second server 109, and one or more insurance companies before and/or at the time of underwriting the insurance policy for the user. In an embodiment, the MVR of the user may be accessed by at least one of the first server 108, second server 109, and one or more insurance companies at the time of or a predetermined time before renewal of an insurance policy of the user.

In an embodiment, the external source 112 may be a repository or a knowledge database from where the user credit history may be accessed by the second server 109. In an embodiment, the user credit history may be managed by an external credit rating agency and the second server 109 may access the user credit history on per user basis. In an embodiment, the user credit history may be accessed before and/or at the time of underwriting an insurance policy for the user. The second server 109 may refer a historical data received from the external source 112 to determine that the user is the defaulter and/or to identify the at least one portion of the data as anomalous to facilitate analysis and a decision making.

Accordingly, the second server 109 determines the service eligibility of the at least one user by selectively allowing the user to receive the service based on selecting the user corresponding to the risk profile classified as the moderate risk or the low risk profile, and rejecting the at least one user corresponding to the high risk profile. In other scenario, the moderate and high risk user may be levied with stringent conditions with respect to underwriting of an agreement and not rejected or refrained.

In an embodiment, wherein the devices 102, 104 may be construed as integrated with each other as a single user device 102. While the description of FIG. 1 refers the user device 102 and the agent device 104 as separate devices, in an embodiment, the same shall not be construed as limiting and the description may be expandable to cover the scenarios wherein the devices 102, 104 may be construed as integrated with each other as the single user device 102.

In an embodiment, the first server 108 and the second server 109 may be construed as integrated with each other as a single server 109. While the description of FIG. 1 refers the first server 108 and the second server 109 as separate-devices, in an embodiment, the same shall not be construed as limiting and the description may be expandable to cover a scenario wherein the servers 108, 109 may be construed as integrated with each other as a single device/server 109. In another embodiment, the first server 108 and the second server 109 may be logical/virtual partitions that are segmented from each other via virtual segmentation or any other known segmentation technique.

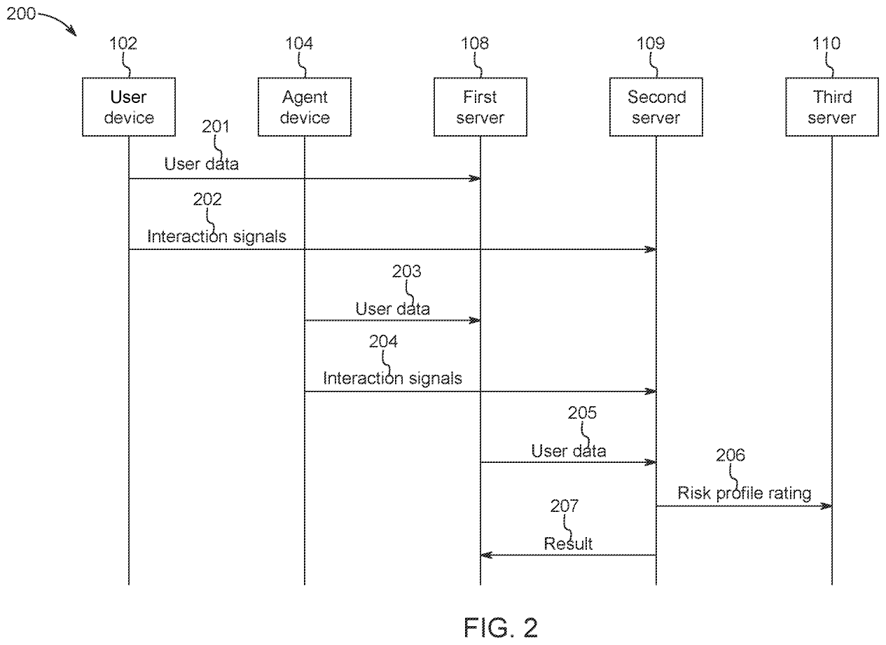

FIG. 2 illustrates a signal flow diagram for user behavior-based risk profile rating in accordance with an embodiment. In FIG. 2, an exemplary signal flow diagram 200 is disclosed. FIG. 2 will be described in conjunction with terms and description used previously in FIG. 1. The signal flow diagram 200 includes flow of data involving the user device 102, the agent device 104, the first server 108, the second server 109, and the third server 110.

As a prerequisite, the user device 102 may be associated with a user who intends to purchase a service. The user may download an app or visit a website offering the required service via the user device 102.

In an embodiment, when the user downloads the app or visits the website on the user device 102, an embedded plug-in and/or module may be invoked on the app or web page. The embedded module or plug-in detects one or more movements of the cursor on the user device 102 while the user fills the application form for purchasing the service. In an embodiment, the embedded plug-in and/or module may constantly detect the interaction of the user, via the user device 102, with the app or website. In an embodiment, the user behavior at the time of purchasing the service may be analyzed to assess the risk of fraudulent information.

At step 201, an input data is received from a user through at least one user interface which may be an application form including a plurality of fields for receiving the input data. Specifically, the data entered by the user via the user device 102 on various fields of the application form is captured and received by the first server 108. In an embodiment, the input data may be received by the first server 108 in real-time or non-real time. In an embodiment, the input data may be captured separately from the detected movements of the cursor on the user device 102 by the module or plug-in. In an embodiment, the input data may include the actual content filled in the application form and/or personal identity information of the user.

At step 202, an interaction data associated with an interaction of the user with the user interface is received based on assessment of interaction of the user with the user interface. The interaction data depicts the interaction between the user (via the user device 102) and the app or website. The interaction data is captured as one or more interaction signals by the module or plug-in invoked on the app or website on the user device 102. The one or more captured interaction signals may be received by the second server 109 for analysis and inference. However, it will be apparent to one with ordinary skill in the art that only non-personal identity information associated with the user may be collected by the app or website, and transmitted to the second server 109 at an interaction level.

In an embodiment, the one or more interaction signals may be captured at instances such as but not limited to a user changing options frequently on various input fields of the application form, performing comparisons to check the impact on insurance premium, user filling the input fields such as age, salary etc. at once or in multiple chances, the user copying and pasting the text onto the input fields provided in the application form, number of times an entry on the input field is updated, time taken by the user to fill each input field on the application form, and/or time taken by the user to fill the entire application form. In an embodiment, the one or more interaction signals related to the user interaction with the app or website may be sent periodically to the second server 109. In an embodiment, the one or more interaction signals may be transmitted to the second server 109 after every configurable time period such as but not limited to every 5 seconds. For instance, if a user moves away from the web page, a packet of information may be sent to the second server 109. In another instance, when the user submits the application form, a packet of information may be sent to the second server 109.

In an embodiment, the captured interaction data received from assessment of the user interface includes at least one parameter including, but not limited to, a frequency of change in options selected from a drop box menu control provided at the at least one user interface, a plurality of comparisons to check costs associated with at least one service, a number of attempts while inputting a confidential information at the at least one user interface, a number of copy-paste actions subjected to a plurality of text fields at the at least one user interface, a number of times an entry is updated in at least one text field at the at least one user interface, a time duration spent per text field out of a plurality of text fields at the at least one user interface, a number or a sequence of selections performed over at least one application or at least one website associated with the at least one user interface, and a total time duration expended by the at least one user over the at least one user interface.

Optionally, the user may opt for an agent as an associate to fill the application form on behalf of the user for purchasing an insurance policy. In an embodiment, the agent may contact the user via telephone call or any communication medium. In an embodiment, the agent may exchange information related to the insurance policy with the user and the agent may feed the information into a web page related to insurance displayed on the agent device 104. An embedded plug-in and/or module may be invoked on the app or web page of the agent device 104 for monitoring the sequence of actions or clicks performed by the agent on the agent device 104.

At step 203, as the agent fills the application form-related on the web page, the data entered by the agent via the agent device 104 on various fields of the application form is captured and received by the first server 108. In an embodiment, the input data captured from the agent device 104 may be received by the first server 108 in real-time or non-real time.

At step 204, as the agent fills the application form-related on the web page, one or more interaction signals may be captured by the embedded plugin and/or module present on the web page of the agent device 104. The one or more interaction signals captured by the embedded plugin and/or module present on the web page of the agent device 104 may be sent to/received by the second server 109. In an embodiment, the one or more interaction signals may be captured from the interaction of the agent via the agent device 104 with the app or website.

At step 205, the first server 108 may communicate the input data captured from the user device 102 or the agent device 104 to the second server 109 based on certain conditions. The second server 109 determines a risk profile of the at least one user based on the input data and the interaction data received in step 204. Such risk profiled refers the risk of transaction with user.

In an embodiment, the second server 109 may use the one or more interaction signals or periodically transmitted packets of information from the user device 102 to determine in real-time or non-real time whether the user being interacted with is risky or not. In an embodiment, the second server 109 may utilize the input data received from the first server 108 along with the one or more interaction signals to perform risk assessment or create a risk profile for the user. In an embodiment, the second server 109 may receive the one or more interactions signals from the user device 102 after every predetermined time period and instantaneously perform risk assessment of the user in real-time. In an embodiment, the second server 109 may use the one or more interaction signals or periodically transmitted packets of information from the agent device 104 to determine in real-time or non-real time whether the agent is suspicious or not. The agent, on behalf of the user, may be entering details fraudulently on the application form to complete his/her sales target. Further, historic data associated with policies sold by each agent may be utilized in conjunction with the one or more interaction signals captured from the agent device 104 to detect suspicious behavior of the agent. In an embodiment, the second server 109 may utilize the driving behavior analysis feature of the app in conjunction with the user historical data retrieved from the external source 112 to ascertain if the user is suspicious, risky, or providing fraudulent information. There may be instances where traffic violations or certain violations are not recorded in the user historical data such as MVR data but the driving behavior analysis feature may help in revealing contradictory/fraudulent information.

In an embodiment, the determining of the risk profile by the second server 109 is based on predicting a risk associated with the user based on the input data and the interaction data. For such purpose, the second server 109 computes a risk assessment score associated with the at least one user based on the predicted risk. The computed risk assessment score is classified as one of low risk, moderate risk, or severe risk, wherein the classification indicates the risk profile of the at least one user. In an alternate example, an artificial neural network (ANN) may be trained based on a data set comprising the input data and the at least one interaction data to predict a risk factor associated with the at least one user. Based on such predicted risk factor, the risk profile of the at least one user is formed. Thereafter, the formed risk profile may be classified as one of a low risk, moderate risk or severe risk.

In an embodiment, the sequence of clicks or actions performed by the user during the interaction between the user via the user device 102 with the app or website during the step 202 may be utilized by the second server 109 to create a digital fingerprint or behavior profile of the user. Alternatively, the second server 109 may collect the one or more interaction signals from the agent device 104 to create a digital fingerprint or behavior profile of the user.

In an embodiment, the second server 109 may use the digital fingerprint or the behavior profile of the user to create a risk profile of the user. The risk profile may classify the user as being a high-risk, moderate risk, or no risk/safe user. In an embodiment, the second server 109 may analyze the behavior profile to create the risk profile of the user. Based on the risk profile, the second server 109 may compute a risk profile rating for each user. The risk profile rating may pertain to a specific rating for no-risk/safe, moderate risk, or high-risk user. In an embodiment, the high risk or moderate risk users may be users who input fraudulent or suspicious information on the application form. In an embodiment, the second server 109 may store the risk profile and the risk profile rating for each user temporarily, for a fixed time period, or permanently.

At step 206, the second server 109 may share the risk profile rating of the user(s) with the service providers on the app or website via the third server 110. In an embodiment, the second server 109 may send the computed risk profile rating of the user(s) to one or more insurance companies via the third server 110. In an embodiment, the risk profile rating of a particular user may indicate, to the one or more insurance companies associated with the third server 110, a risk of engaging in business with the particular user. Accordingly, the one or more insurance companies may take the risk profile rating into consideration to decide whether the policy for the particular user should be underwritten or not.

In an embodiment, the second server 109 determines an eligibility of the user to receive at least one service based on the determination of the risk profile. In an example, such service eligibility determination includes deciding to provide the service to the user. Such decision includes selecting the user corresponding to the risk profile classified as the moderate risk or the low risk profile, and rejecting the at least one user corresponding to the high risk profile. Accordingly, the second server 109 may decide whether step 206 is to be performed or not. In an embodiment, the second server 109 may decide that the risk profile rating is not to be shared with the one or more insurance companies for the users determined to be risky/suspicious. In an embodiment, the second server 109 may decide to share the risk profile rating with the one or more insurance companies for the users determined to be safe. In an embodiment, the second server 109 may decide whether to proceed with underwriting an insurance policy for a user or not based on the risk assessment.

In an embodiment, the one or more insurance companies may choose to underwrite the insurance policy for the particular user whose risk profile rating is shared by the second server 109. Accordingly, the one or more insurance companies may send the terms, conditions, and/or parameters of the insurance policy via the third server 110 to the second server 109. In an embodiment, one or more terms, conditions, and/or parameters of the insurance policy may be changed by the one or more insurance companies based on the risk profile rating of the user. In an embodiment, one or more terms, conditions, and/or parameters of the insurance policy may be changed by the one or more insurance companies for moderate risk users. In an embodiment, one or more terms, conditions, and/or parameters of the insurance policy may remain same as mentioned in quote issued on the app or website for no-risk/safe users. In an embodiment, the one or more insurance companies may choose to refrain from underwriting an insurance policy for high risk or suspicious users.

At step 207, the second server 109 provides service to the user or refrains therefrom, based on the risk profile of the user. In an embodiment, the providing at least one service to the user (i.e. insurance company choosing to underwrite insurance policy for the user) is based on the risk profile of the user such that service is provided to the at least one user based on a determination that the risk profile indicates low risk associated with the at least one user. In other situation, the insurance companies may choose to refrain from underwriting an insurance policy for the user based on determination that the risk profile indicates high risk or moderate risk associated with the user. In an example, only the high risk profiles may be refrained from underwriting and the modified risk profile may be underwritten with an insurance agreement having limitations, higher insurance premium etc., to disincentivize the user from remaining even as moderately risky. In yet another example, the high risk profiles may not be refrained and underwritten with insurance agreements high on limitations and insurance premium as compared with the moderately risky users.

FIG. 3 illustrates a block diagram of a server for user behavior-based risk profile rating in accordance with an embodiment. FIG. 3 will be explained in conjunction with the description provided above for FIGS. 1 and 2. In FIG. 3, block diagram of an exemplary server, such as second server 109, is depicted. The second server 109 may include processor 302, memory 304, and communication interface 306.

The processor 302 may include suitable logic, circuitry, interfaces, and/or code that may be configured to execute a set of instructions stored in the memory 304. The processor 302 may be implemented based on a number of processor technologies known in the art. The processor 302 may include, but is not limited to, one or more digital processors, e.g., one or more microprocessors, microcontrollers, an X86-based processor, a Reduced Instruction Set Computer (RISC) processor, Advanced RISC Machine (ARM)-based processor, an Application-Specific Integrated Circuit (ASIC) processor, a Complex Instruction Set Computing (CISC) processor, Digital Signal Processors (DSPs), Field Programmable Gate Arrays (FPGAs), Complex Programmable Logic Devices (CPLDs), or any mix thereof.

The memory 304 may include suitable logic, circuitry, and/or interfaces that may be configured to store a machine code and/or a computer program with at least one code section executable by the processor 302. Examples of implementation of the memory 304 may include, but are not limited to, Random Access Memory (RAM), Read Only Memory (ROM), Flash memory, Hard Disk Drive (HDD), and/or other memories.

The memory 304 may include, but not limited to, Rules Engine, Training Model, Scoring Module, Rating Generation Module, Behavior-based Risk Profile Data, User Profiles, Insurance Company Profiles (A . . . n), Authentication Module, Determination Module, Mapping Module, Signal Generation Module, Location Module, Artificial Intelligence (AI) Module, and/or Machine Learning (ML) Module. Each of these modules may be capable of receiving and sending data to every other module.

In an embodiment, the Rules Engine and the Training Module may be configured to compute risk based on the one or more signals captured from the user interaction or the agent interaction with the app or website. For every input method, there may be a way to configure weightage of each user interaction or the one or more interaction signals. In an embodiment, the Rules Engine and the Training Module may be built to detect false counts at the second server 109. However, the Rules Engine and the Training Module may determine which detected user actions are to be considered for determining the risk profile of the user. For example, if changing an entry is a one-off instance for a user in a non-critical field of the application form then that change may not be considered for assessing the risk profile of the user. Alternatively, for critical fields on the application form, one-off instances may be analyzed strictly by the Rules Engine and the Training Module for assessing the risk associated with the user. In an embodiment, the Scoring Module may be weighted based on which glitches of the input fields on the application form are detected. In an embodiment, the Training Model may implement self-learning feedback loop where over time, when data is gathered, the prediction of the user behavior-based risk profile rating system gets better. Accordingly, the Scoring Module may compute near accurate confidence score after few initial predictions.

In machine learning, a common task is the study and construction of algorithms that can learn from and make predictions based on data sets. Such algorithms function by making data-driven predictions or decisions, through building a mathematical model from input data. These input data used to build the model are usually divided in multiple data sets. In particular, three data sets are commonly used in various stages of the creation of the model: training data sets, validation data sets, and test data sets.

The model is initially fit on a “training data set,” which is a set of examples used to fit the parameters of the model. The model is trained on the training data set using a supervised learning method. The model is run with the training data set and produces a result, which is then compared with a target, for each input vector in the training data set. Based at least on the result of the comparison and the specific learning algorithm being used, the parameters of the model are adjusted. The model fitting can include both variable selection and parameter estimation. Successively, the fitted model is used to predict the responses for the observations in a second data set called the “validation data set.”

The second server 109 may be part of a larger computer system and/or maybe operatively coupled to a computer network (a “network”) with the aid of a communication interface to facilitate the transmission of and sharing data and predictive results. The computer network may be a local area network, an intranet and/or extranet, an intranet and/or extranet that is in communication with the Internet, or the Internet. The computer network in some cases is a telecommunication and/or a data network, and may include one or more computer servers. The computer network, in some cases with the aid of a computer system, may implement a peer-to-peer network, which may enable devices coupled to the computer system to behave as a client or a server.

The second server 109 also includes one or more I/O Managers as software instructions that may run on the one or more processors and implement various communication protocols such as User Datagram Protocol (UDP), MODBUS, MQTT, OPC UA, SECS/GEM, Profinet, or any other protocol, to access data in real-time from disparate data sources via any communication network, such as Ethernet, Wi-Fi, Universal Serial Bus (USB), ZIGBEE, Cellular or 5G connectivity, etc., or indirectly through a device's primary controller, through a Programmable Logic Controller (PLC) or through a Data Acquisition (DAQ) system, or any other such mechanism.

In accordance with the present disclosure, the notification and alerts are sounded by the second server 109 based on the identification of rare items, events or observations which raise suspicions by differing significantly from the baseline of the data. Predictive Analysis encompasses a variety of statistical techniques from data mining, predictive modelling, and machine learning, which analyze current and historical facts to make predictions about future or otherwise unknown events.

In accordance with an embodiment of the present disclosure, machine learning model training may happen at the edge, close to the data source, or on any remote computer. In certain embodiments, the mathematical representations of the machine learning model training details are stored in memory close to the source of input data. Disparate relevant data streams are fed in memory to a machine learning runtime engine running on the second server 109 close to the data source in order to get low latency inferencing. Communication between the second server 109 and a client may be via a communication network such as local area network (LAN), a general wide area network (WAN), and/or a public network (e.g., the Internet, Wi-Fi, 5G) via network adapter etc.

The user behavior-based risk profile rating system may have multiple applications. For instance, the risk profiles created by the second server 109 for each user signing up for an auto insurance service may be used by any company/agent providing an online auto insurance service on their app or website to differentiate between suspicious/risky and safe users. The created risk profiles would also enable such companies to determine users which may be offered new services or continued services.

Further, the user behavior-based risk profile rating system reduces the risk of having anonymous people fill forms on the website or apps.

As a yet another application, the insurance companies may use or utilize the risk profile ratings or risk assessment calculated for the users using the user behavior-based risk profile rating system. The calculated risk assessment for the users would enable the insurance companies to incur reduced losses since it will be beneficial to underwrite insurance policies for those users whose profile is more accurate and/or is not subjected to fraud or false information.

The terms “including,” and/or “includes,” and “having,” as used in the specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition, or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures, and techniques other than those specifically described herein can be applied to the practice of the invention as broadly disclosed herein without resort to undue experimentation. All art-known functional equivalents of methods, devices, device elements, materials, procedures, and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation. Additionally, it should be understood that the various embodiments of the user behavior-based risk profile rating system described herein contain optional features that can be individually or together applied to any other embodiment shown or contemplated here to be mixed and matched with the features of that system.

While the invention has been described with respect to a limited number of embodiments, those skilled in the art, having benefit of this disclosure, will appreciate that other embodiments can be devised which do not depart from the scope of the invention as disclosed herein.

1. A method implemented in a behavior-based risk-profiling system for profiling a user, said method comprising:
receiving an input data from at least one user through at least one user interface;
receiving an interaction data associated with an interaction of the at least one user assessed from the at least one user interface;
determining a risk profile of the at least one user based on a data set comprising the input data and the interaction data; and
providing at least one service to the user based on the risk profile.

2. The method of claim 1, wherein the determining the risk profile further comprises:
training at least one artificial neural network (ANN) based on the data set comprising the input data and the interaction data received over a period of time; and
implementing the ANN to predict a risk associated with the at least one user.

3. The method of claim 1, wherein the at least one user interface comprises at least one application form, wherein the at least one application form comprises a plurality of fields for receiving the input data.

4. The method of claim 1, wherein the interaction data is received by at least one user device of the at least one user.

5. The method of claim 1, wherein determining the risk profile comprises predicting a risk associated with the at least one user based on the input data and the interaction data, wherein the predicting the risk comprises:
computing a risk assessment score associated with the at least one user based on the predicted risk; and
classifying the computed risk assessment score to indicate the risk associated with the at least one user.

6. The method of claim 5, wherein providing the at least one service to the user comprises:
deciding to provide the at least one service to the user based on the determination of the risk profile.

7. The method of claim 1, wherein the input data comprises at least one of a content, and a personal information associated with the at least one user.

8. The method of claim 1, wherein the interaction data received from assessment of the at least one user interface comprises at least one parameter of:
a frequency of change in selected options from a drop box control provided at the at least one user interface;
a plurality of comparisons to check costs associated with at least one service;
a number of attempts while inputting a confidential information at the at least one user interface;
a number of copy-paste actions subjected to a plurality of text fields at the at least one user interface;
a number of times an entry is updated in at least one text field at the at least one user interface;
a time duration spent per text field out of a plurality of text fields at the at least one user interface;
a number or a sequence of selections performed over at least one application or at least one website underlying the at least one user interface; and
a total time duration expended by the at least one user over the at least one user interface.

9. The method of claim 6, wherein the deciding to provide the at least one service to the user is based on at least one of:
determining a likelihood of the at least one user being a defaulter for the at least one service; and
identifying at least one portion of the input data received from the at least one user as fraudulent.

10. The method of claim 2, further comprising validating the prediction of the at least one ANN based on at least one of:
a communication from a remote server to determine that the at least one user is a defaulter and/or to identify at least one portion of the input data as anomalous; and
a historical data received from a knowledge database to determine that the at least one user is a defaulter and/or to identify at least one portion of the input data as anomalous.

11. A method implemented in a behavior-based risk profiling system for determining service-eligibility of a user, said method comprising:
receiving an input data from at least one user through at least one user interface;
receiving an interaction data associated with an interaction of the at least one user assessed from the at least one user interface;
determining a risk profile associated with the at least one user based on a data set comprising the input data and the interaction data; and
determining an eligibility of the at least one user to receive at least one service based on the determination of the risk profile.

12. The method of claim 11, wherein the determining the risk profile comprises:
training an artificial neural network (ANN) based on the data set comprising the input data and the at least one interaction data to predict a risk associated with the at least one user; and
forming the risk profile of the at least one user based on the prediction of the risk.

13. The method of claim 12, wherein the determining of the service eligibility of the at least one user comprises selectively allowing the at least one user to receive the at least one service based on the risk profile.

14. The method of claim 13, wherein the determining of the service eligibility is based on at least one of:
determining a likelihood of the at least one user being a defaulter for the at least one service; and
identification of at least one portion of the input data received from the at least one user as fraudulent.

15. The method of claim 14, further comprising:
validating the prediction of the at least one ANN based on communication from a remote server to determine the at least one user is the defaulter and/or to identify the at least one portion of the input data is anomalous.

16. A behavior-based risk profiling system for determining service-eligibility of a user, said system comprising:
an authentication module configured to receive an input data from at least one user through at least one user interface;
a determination module configured to receive an interaction data associated with an interaction of the at least one user with the at least one user interface;
an AI module configured to determine a risk profile associated with the at least one user based on a data set comprising the input data and the interaction data; and
a rating generation module configured to determine eligibility of the at least one user to receive at least one service based on determination of the risk profile.

17. The system of claim 16, wherein the AI module is configured to:
train an artificial neural network (ANN) based on the data set comprising the input data and the interaction data to predict a risk associated with the at least one user; and
form the risk profile of the at least one user based on the prediction of the risk.

18. The system of claim 17, wherein the rating generation module configured to determine the eligibility of the at least one user is configured to allow the at least one user to receive the at least one service based on the risk profile.

19. The system of claim 18, wherein the rating generation module is configured to determine the service eligibility based on at least one of:
a likelihood of the at least one user being a defaulter for the at least one service; and
identification of at least one portion of the input data received from the at least one user as fraudulent.

20. The system of claim 19, wherein the AI module is further configured to:
validate the prediction of the risk from the at least one ANN based on communication from a remote server to determine the at least one user is the defaulter and/or to identify the at least one portion of the input data is anomalous.
